(19) United States
(12) Patent Application Publication
(10) Pub. No.: US 2006/0045046 A1
(43) Pub. Date: Mar. 2, 2006

(54) Uplink transmission power control in wireless communication system

(75) Inventors: Bong Hoe Kim, Gyeonggi-do (KR); Joon Kui Ahn, Seoul (KR); Hak Seong Kim, Seoul (KR); Dong Wook Roh, Seoul (KR); Dong Youn Seo, Seoul (KR); Seung Hwan Won, Gyeonggi-do (KR)

Correspondence Address: JONATHAN Y. KANG, ESQ.;LEE, HONG, DEGERMAN,, KANG & SCHMADEKA, 801 S. Figueroa Street, 14th Floor, Los Angeles, CA, 90017, US

(73) Assignee: LG Electronics Inc.

(21) Appl. No.: 11/202,289

(22) Filed: Aug. 10, 2005

(30) Foreign Application Priority Data
Aug. 11, 2004 (KR) 10-2004-0063123

(51) Int. Cl. H04Q 7/00

(52) U.S. Cl. 370/329

(57) ABSTRACT

A method of controlling uplink transmission power to reduce interference in a wireless communication system comprises establishing an uplink communication through an uplink dedicated channel between a user equipment and a base station, wherein the base station is operationally connected to a radio network controller. The method also comprises receiving a scheduling command from the base station for controlling transmission power of the user equipment, wherein the scheduling command is determined from scheduling information comprising transmission power information received from the radio network controller, the transmission power information being determined in response to information associated with at least one user equipment that is in soft handover relationship with another base station. The method also comprises controlling uplink data transmission in response to the scheduling command.

### CROSS-REFERENCE TO RELATED APPLICATIONS

Pursuant to 35 U.S.C. § 119(a), this application claims the benefit of earlier filing date and right of priority to Korean Application No. 10-2004-0063123, filed on Aug. 11, 2004, the contents of which are hereby incorporated by reference herein in their entirety.

### FIELD OF THE INVENTION

The present invention relates generally to a wireless communication system and, more particularly, to uplink transmission power control in a wireless communication system.

### BACKGROUND OF THE INVENTION

Node-B scheduling is a process in which a node-B controls uplink transmissions of user equipments (UEs) present in a cell controlled by the node-B when the UEs transmit packets in the uplink. The control by the node-B is in real time. Such control may more efficiently utilize uplink resources and improve cell throughput and capacity.

In a related art node-B scheduling method, the node-B transmits a command for limiting uplink packet transmission power of the UEs at each transmission time interval (TTI). This limitation allows rise over thermal (ROT) in the cell to be maintained at an appropriate level.

More specifically, at each TTI, the node-B notifies the UEs of their respective maximum power offset values (e.g., amplitudes) of uplink dedicated physical control channels (e.g., DPCCHs) that may be applied when the UEs transmit packets. The UEs may then transmit packets at a data rate selected from a range of data rates allowable within the maximum power offset values. For each UE, a scheduling command may be applied to any uplink channel other than the uplink DPCCH, or only to a specific uplink channel.

FIG. 1 is a diagram illustrating a related art uplink node-B scheduling method.

Referring to FIG. 1, a first UE (UE1) 14, a second UE (UE2) 15, and a third UE (UE3) 16 transmit data in the uplink according to a scheduling command of a first node-B (node-B1) 12. The first UE 14 communicates with the first node-B 12. The second UE 15 and the third UE 16 perform a soft handover in which each of the second and third UEs 15 and 16 is in simultaneous communication with the first and second node-Bs 12 and 13.

In such case, the second node-B 13 may schedule uplink transmissions pertaining only to the UEs belonging to the cell controlled by the second node-B 13. Therefore, the second node-B 13 may not effectively control interference caused by uplink transmissions of the UEs 14, 15 and 16 belonging to the cell controlled by the first node-B 13 when the interference is too high. The second node-B 13 also may not be able to determine the interference to the first node-B 12 caused by UEs whose transmissions are scheduled by the second node-B 13. Thus, the second node-B 13 may not be able to perform scheduling with consideration of interference to the first node-B 12 and neighboring cells.

### SUMMARY OF THE INVENTION

Accordingly, the present invention is directed to uplink transmission power control that substantially obviates one or more problems due to limitations and disadvantages of the related art.

An object of the present invention is to provide scheduling of uplink transmission power such that a node-B performs scheduling of uplink transmission power of user equipment (UE) using information received from a radio network controller (RNC), in order to achieve efficient scheduling of uplink channels.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, in one embodiment, a method of controlling uplink transmission power to reduce interference in a wireless communication system comprises establishing an uplink communication through an uplink dedicated channel between a user equipment and a base station, wherein the base station is operationally connected to a radio network controller. The method also comprises receiving a scheduling command from the base station for controlling transmission power of the user equipment, wherein the scheduling command is determined from scheduling information comprising transmission power information received from the radio network controller, the transmission power information being determined in response to information associated with at least one user equipment that is in soft handover relationship with another base station. The method also comprises controlling uplink data transmission in response to the scheduling command.

The scheduling command may be associated with a corresponding maximum transmission power level for each one of a plurality of user equipment that are operatively in communication with the radio network controller. The scheduling command may be applied to controlling the uplink dedicated channel. The scheduling command may comprise an absolute power level. Alternatively, the scheduling command comprise a relative power level. The base station may be a node-B. The transmission power information may be determined in response to interference to a neighboring base station by the user equipment. The interference may comprise at least one of (1) distance of the user equipment from the neighboring base station, (2) fading and (3) a speed of the user equipment. The user equipment that is closer to a cell boundary controlled by the base station may be assigned a lower transmission power level than the user equipment that is closer to the base station.

In another embodiment, a method of scheduling uplink transmission power to reduce interference in a wireless communication system comprises establishing an uplink communication through an uplink dedicated channel between a user equipment and a base station, wherein the base station is operationally connected to a radio network controller. The method also comprises transmitting a scheduling command to the user equipment for controlling transmission power of the user equipment, wherein the scheduling command is determined from scheduling information comprising transmission power information received from the radio network controller, the transmission power information being determined in response to information associated with at least one user equipment that is in soft handover relationship with another base station, wherein the user equipment controls uplink data transmission in response to the scheduling command.

The foregoing and other objects, features, aspects and advantages of the present invention will become more apparent from the following detailed description of the present invention when taken in conjunction with the accompanying drawings. It is to be understood that both the forgoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principles of the invention.

FIG. 1 is a diagram illustrating a related art uplink node-B scheduling method.

FIG. 2 is a diagram illustrating an uplink node-B scheduling method, according to an embodiment of the present invention.

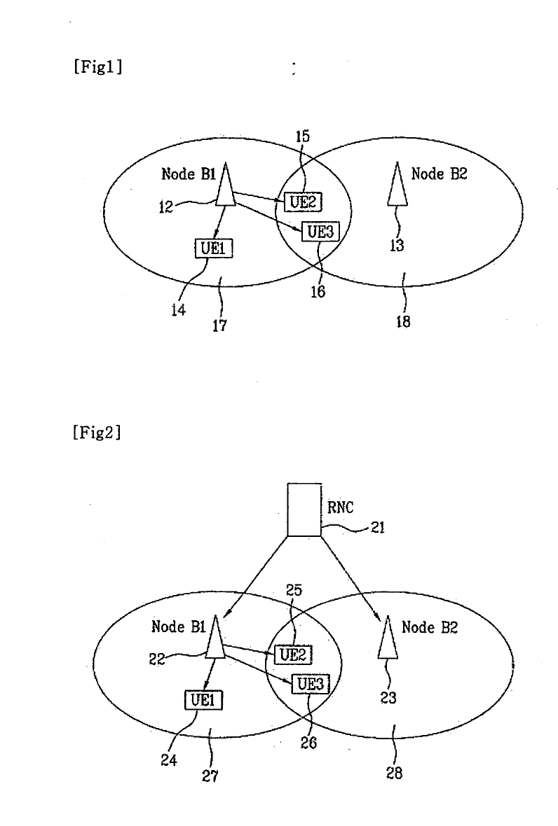

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

Node-B scheduling of uplink transmission power of user equipments (UEs) is applied to Enhanced-Dedicated Channels (E-DCHs) for high packet transmission. According to an embodiment of the present invention, each node-B receives a control command from a radio network controller (RNC) regarding a maximum transmission power that the node-B may allocate to UEs belonging to a cell controlled by the node-B. As such, the node-B may account for interference with neighboring cells in the performance of scheduling.

FIG. 2 is a diagram illustrating an uplink node-B scheduling method, according to an embodiment of the present invention. The embodiment described with reference to FIG. 2 may be used to explain an uplink scheduling method when a neighboring cell is present.

Referring to FIG. 2, a first UE (UE1) 24, a second UE (UE2) 25, and a third UE (UE3) 26 transmit data in the uplink according to a scheduling command of a first node-B (node-B1) 22. The first UE 24 communicates with the first node-B 22. The second UE 25 and the third UE 26 perform a soft handover.

Referring again to FIG. 2, the first UE 24 is located at a distance from a second node-B 23. Therefore, the first UE 24 causes relatively low interference to uplink transmission of other UEs belonging to a cell 28 controlled by the second node-B 23. However, since the second UE 25 and the third UE 26 are relatively closer to the second node-B 23 than the first UE 24, the second and third UEs 25 and 26 cause relatively higher interference to uplink transmission of other UEs belonging to the cell 28 controlled by the second node-B 23.

Referring again to FIG. 2, the three UEs 24, 25, and 26 belonging to a cell 27 controlled by the first node-B 22 may cause interference to uplink transmission of UEs belonging to the cell 28 controlled by the second node-B 23 neighboring the first node-B 22. In such case, factors which determine interference include not only the distance from the second node-B 23 but also fading and movement speed of the UEs.

A RNC 21 transfers scheduling information to the first node-B 22 related to the maximum transmission power which may be allocated to the first, second, and third UEs 24, 25 and 26. The scheduling information may account for interference which the UEs in the first node-B 22 cause to the neighboring cell 28 (i.e., interference caused to the second node-B 23). In the embodiment, higher uplink transmission power is allocated to each of the first, second, and third UEs 24, 25 and 26 according to decreasing distance from the second node-B 23. That is, the UE1 is allocated more uplink transmission power than the UE2, and the UE2 is allocated more uplink transmission power than the UE3.

Therefore, uniform throughput and capacity may be maintained over a cell controlled by the first node-B 22. Furthermore, interference with the cell controlled by the second node-B 23 may be minimized.

In one embodiment, a method of controlling uplink transmission power to reduce interference in a wireless communication system comprises establishing an uplink communication through an uplink dedicated channel between a user equipment and a base station, wherein the base station is operationally connected to a radio network controller. The method also comprises receiving a scheduling command from the base station for controlling transmission power of the user equipment, wherein the scheduling command is determined from scheduling information comprising transmission power information received from the radio network controller, the transmission power information being determined in response to information associated with at least one user equipment that is in soft handover relationship with another base station. The method also comprises controlling uplink data transmission in response to the scheduling command.

The scheduling command may be associated with a corresponding maximum transmission power level for each one of a plurality of user equipment that are operatively in communication with the radio network controller. The scheduling command may be applied to controlling the uplink dedicated channel. The scheduling command may comprise an absolute power level. Alternatively, the scheduling command comprise a relative power level. The base station may be a node-B. The transmission power information may be determined in response to interference to a neighboring base station by the user equipment. The interference may comprise at least one of (1) distance of the user equipment from the neighboring base station, (2) fading and (3) a speed of the user equipment. The user equipment that is closer to a cell boundary controlled by the base station may be assigned a lower transmission power level than the user equipment that is closer to the base station.

In another embodiment, a method of scheduling uplink transmission power to reduce interference in a wireless communication system comprises establishing an uplink communication through an uplink dedicated channel between a user equipment and a base station, wherein the base station is operationally connected to a radio network controller. The method also comprises transmitting a scheduling command to the user equipment for controlling transmission power of the user equipment, wherein the scheduling command is determined from scheduling information comprising transmission power information received from the radio network controller, the transmission power information being determined in response to information associated with at least one user equipment that is in soft handover relationship with another base station, wherein the user equipment controls uplink data transmission in response to the scheduling command.

The present invention may allow interference to neighboring cells to be minimized by performing scheduling of uplink transmission power of user equipments using information received from a radio network controller.

Although various embodiments of the present invention have been described with reference to a node-B, the present invention may be applied to a base station or any other type of fixed communication station.

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

What is claimed is:

1. A method of controlling uplink transmission power to reduce interference in a wireless communication system, the method comprising:
establishing an uplink communication through an uplink dedicated channel between a user equipment and a base station, wherein the base station is operationally connected to a radio network controller;
receiving a scheduling command from the base station for controlling transmission power of the user equipment, wherein the scheduling command is determined from scheduling information comprising transmission power information received from the radio network controller, the transmission power information being determined in response to information associated with at least one user equipment that is in soft handover relationship with another base station; and
controlling uplink data transmission in response to the scheduling command.

2. The method of claim 1, wherein the scheduling command is associated with a corresponding maximum transmission power level for each one of a plurality of user equipment that are operatively in communication with the radio network controller.

3. The method of claim 1, wherein the scheduling command is applied to controlling the uplink dedicated channel.

4. The method of claim 1, wherein the scheduling command comprises an absolute power level.

5. The method of claim 1, wherein the scheduling command comprises a relative power level.

6. The method of claim 1, wherein the base station is a node-B.

7. The method of claim 1, wherein the transmission power information is determined in response to interference to a neighboring base station by the user equipment.

8. The method of claim 7, wherein the interference comprises at least one of (1) distance of the user equipment from the neighboring base station, (2) fading and (3) a speed of the user equipment.

9. The method of claim 1, wherein the user equipment that is closer to a cell boundary controlled by the base station is assigned a lower transmission power level than the user equipment that is closer to the base station.

10. A method of scheduling uplink transmission power to reduce interference in a wireless communication system, the method comprising:
establishing an uplink communication through an uplink dedicated channel between a user equipment and a base station, wherein the base station is operationally connected to a radio network controller; and
transmitting a scheduling command to the user equipment for controlling transmission power of the user equipment, wherein the scheduling command is determined from scheduling information comprising transmission power information received from the radio network controller, the transmission power information being determined in response to information associated with at least one user equipment that is in soft handover relationship with another base station, wherein the user equipment controls uplink data transmission in response to the scheduling command.

11. The method of claim 10, wherein the scheduling command is associated with a corresponding maximum transmission power level for each one of a plurality of user equipment that are operatively in communication with the radio network controller.

12. The method of claim 10, wherein the scheduling command is applied to controlling the uplink dedicated channel.

13. The method of claim 10, wherein the scheduling command comprises an absolute power level.

14. The method of claim 10, wherein the scheduling command comprises a relative power level.

15. The method of claim 10, wherein the base station is a node-B.

16. The method of claim 10, wherein the transmission power information is determined in response to interference to a neighboring base station by the user equipment.

17. The method of claim 16, wherein the interference comprises at least one of (1) distance of the user equipment from the neighboring base station, (2) fading and (3) a speed of the user equipment.

18. The method of claim 10, wherein the user equipment that is closer to a cell boundary controlled by the base station is assigned a lower transmission power level than the user equipment that is closer to the base station.

19. A user equipment adapted to control uplink transmission power to reduce interference in a wireless communication system, the user equipment comprising:
means for establishing an uplink communication through an uplink dedicated channel between a user equipment and a base station, wherein the base station is operationally connected to a radio network controller;
means for receiving a scheduling command from the base station for controlling transmission power of the user equipment, wherein the scheduling command is determined from scheduling information comprising transmission power information received from the radio network controller, the transmission power information being determined in response to information associated with at least one user equipment that is in soft handover relationship with another base station; and
means for controlling uplink data transmission in response to the scheduling command.

20. The user equipment of claim 19, wherein the scheduling command is associated with a corresponding maximum transmission power level for each one of a plurality of user equipment that are operatively in communication with the radio network controller.

21. The user equipment of claim 19, wherein the scheduling command is applied to controlling the uplink dedicated channel.

22. (Network) A network adapted to schedule uplink transmission power to reduce interference in a wireless communication system, the network comprising:
means for establishing an uplink communication through an uplink dedicated channel between a user equipment and a base station, wherein the base station is operationally connected to a radio network controller; and
means for transmitting a scheduling command to the user equipment for controlling transmission power of the user equipment, wherein the scheduling command is determined from scheduling information comprising transmission power information received from the radio network controller, the transmission power information being determined in response to information associated with at least one user equipment that is in soft handover relationship with another base station, wherein the user equipment controls uplink data transmission in response to the scheduling command.

23. The network of claim 22, wherein the scheduling command is associated with a corresponding maximum transmission power level for each one of a plurality of user equipment that are operatively in communication with the radio network controller.

24. The network of claim 22, wherein the scheduling command is applied to controlling the uplink dedicated channel.
